(19) United States
(12) Patent Application Publication
(10) Pub. No.: US 2020/0198495 A1
(43) Pub. Date: Jun. 25, 2020

(54) REAL-TIME ENERGY MANAGEMENT STRATEGY FOR HYBRID ELECTRIC VEHICLES WITH REDUCED BATTERY AGING

(71) Applicant: Ohio State Innovation Foundation, Columbus, OH (US)

(72) Inventors: Giorgio Rizzoni, Columbus, OH (US); Li Tang, Columbus, OH (US)

(21) Appl. No.: 16/612,614

(22) PCT Filed: May 10, 2018
(86) PCT No.: PCT/US2018/031992

§ 371 Date: Nov. 11, 2019

Related U.S. Application Data
(60) Provisional application No. 62/505,189, filed on May 12, 2017.
(60) Provisional application No. 62/546,324, filed on Aug. 16, 2017.

(51) Int. Cl. B60L 58/13; B60W 10/08; B60W 10/06

(52) U.S. Cl. CPC B60L 58/13; B60L 50/61; B60W 10/06; B60W 10/08

(57) ABSTRACT

Systems, methods, and computer program products for managing hybrid energy sources. The use of energy sources may be adjusted by an Adaptive Equivalent Consumption Management Strategy (A-ECMS) implemented on a supervisory controller. The A-ECMS may take into account both fuel economy and battery capacity degradation in a Hybrid Electric Vehicle (HEV) to optimize fuel consumption with consideration of battery aging as determined using a severity factor received from the HEV powertrain. Optimal control approaches including Dynamic Programming and Pontryagin's Minimum Principle may be used to develop energy management strategies that optimally trade off fuel consumption and battery aging. Based on the optimal solutions, a real-time implementable battery-aging-conscious A-ECMS is implemented.

### CROSS-REFERENCE TO RELATED APPLICATIONS

This application claims the benefit of and priority to co-pending U.S. Application Nos. 62/505,189 filed May 12, 2017, and 62/546,324 filed Aug. 16, 2017, the disclosures of which are each incorporated by reference herein in their entireties.

### BACKGROUND

The invention generally relates to supervisory controllers for managing energy in hybrid energy systems, and in particular, to systems, methods, and computer program products that manage energy sources in a Hybrid Electric Vehicle (HEV).

HEVs are vehicles equipped with more than one energy source, and represent a steadily increasing segment of the automotive market. Typically, one energy source in an HEV is a high-capacity source, such as a fuel tank. This high capacity source is complemented by a low-capacity energy storage system that is rechargeable, such as an electrochemical battery pack. Thus, unlike conventional vehicles in which all the power requested by the driver must be provided by combusting chemical fuel, supervisory controllers in HEVs must make decisions on how to distribute the power request among multiple energy sources. A supervisory controller determines this power split using what is known as an energy management strategy.

HEV system technology development is largely driven by increasingly stringent government policies for fuel economy and emissions, and by progress in the technical development of major components such as batteries. HEVs may help vehicles transition from conventional petroleum fueled powertrains to all-electric powertrains by providing a combination of an internal combustion engine and an electric motor/generator, or “electric machine”. The presence of an electrochemical energy storage system, such as a battery pack, allows HEVs to use a smaller internal combustion engine than would otherwise be possible, and to offer features such as engine start/stop, regenerative braking, and motor assist. The complexity of the powertrain results in the performance of an HEV being influenced by many interrelated factors. Control strategies therefore have a large impact on both vehicle performance and cost of operation.

The performance of HEVs in terms of overall energy consumption is dependent on both the efficiency of individual powertrain components and how the powertrain components are managed. Thus, the energy management strategy can have a large impact on the overall energy efficiency of an HEV. The additional degrees of freedom in providing power to the vehicle make it possible to solve various optimization problems in allocating the vehicle power demand between the internal combustion engine and the electric machine. Optimal control methods have been used to design energy management strategies that deliver maximum fuel economy while attempting to preserve other desirable performance and utility features. These conventional HEV energy management systems typically have control objectives designed to maximize fuel economy over a driving cycle without sacrificing vehicle performance.

The fuel economy of HEVs is dependent in part on the capacity of the on-board energy storage system to store energy. However, energy storage systems typically experience degradation in both storage capacity and internal resistance due to several irreversible degradation processes that occur over the life of the vehicle. The rate of battery capacity loss is dictated by many factors including its operating conditions. Factors such as extreme temperature, high discharge or “c-rate”, high or low State Of Charge (SOC), and excessive Depth Of Discharge (DOD) can all contribute to capacity degradation. Because battery packs represent a big part of the total cost of the vehicle, designing batteries to last for the life of a vehicle while still satisfying the energy and power requirements can be challenging.

Energy management strategies for HEVs apply optimal control theory to find a solution that is optimal with respect to a given cost function. Cost functions used include the fuel consumption during a driving cycle or the total emissions of carbon dioxide. Conventional hybrid systems are known to solve the optimal energy management strategy using Dynamic Programming (DP) and Pontryagin's Minimum Principle (PMP). However, because neither of these strategies are causal, the entire cycle or future driving conditions must be known a priori. So, while these strategies can provide optimal solutions for standard economy tests, they typically provide sub-optimal solutions for real-time driving environments in which future driving conditions are unknown.

Thus, there is a need for improved systems, methods, and computer program products for HEVs that extend battery life and reduce overall cost by limiting stresses on the battery while minimizing fuel consumption. Moreover, these improved energy management strategies should function in real-time environments where driving conditions are not predetermined.

### SUMMARY

Embodiments of the invention use a methodology that accounts for battery aging in an energy management strategy for a HEV. An optimal control problem is formulated to minimize fuel consumption as well as battery aging using battery lifetime modeling. The approach relies on the concept of a severity factor map, which is used to quantify the aging effects of different on-vehicle operating conditions on the battery. For proof of concept, the optimal control problem is solved using PMP for various driving cycles. The results thereof are then compared to simulations over the same cycles using the control approach of the present invention. This allows the effectiveness of this new control strategy to be compared with those of standard energy management strategies. An optimization objective that minimizes fuel consumption and battery wear during a driving cycle may be implemented by treating the overall reduction of battery life deriving from its usage as an additional cost that can be quantified using an appropriate description of the aging process.

Embodiments of the invention may be used to account for battery aging in conjunction with any energy management strategy, such as an Equivalent Consumption Minimization Strategy (ECMS), which provides near-optimal energy management for Plug-in Hybrid Electric Vehicles (PHEVs) and HEVs. Embodiments of the invention may be adapted to work with PHEVs, HEVs, and extended range electric powertrains. Severity factors related to battery operation during operation of the vehicle that may be used to adjust the power split between energy sources include temperature (battery and ambient), charge and discharge rates, SOC, and DOD.

If a severe battery aging condition is recognized, battery power may be reduced based on the severity factor, and the power provided by the internal combustion engine increased accordingly to satisfy the total power request. The size of this correction may be selected to produce the smallest possible increase in fuel consumption that will bring the severity factor to an acceptable level. When the HEV operating conditions do not suggest a severe aging condition, the supervisory controller may use any existing energy management strategy, such as an Adaptive Equivalent Consumption Minimization Strategy (A-ECMS).

The above summary may present a simplified overview of some embodiments of the invention to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary supervisory controller for an HEV powertrain in accordance with an embodiment of the invention.

FIG. 2 is a graphical view illustrating a fuel consumption map for an internal combustion engine that may be used in the powertrain of FIG. 1.

FIG. 3 is a graphical view illustrating an efficiency map for an electric machine that may be used in the powertrain of FIG. 1.

FIG. 4 is a graphical view illustrating a severity factor map that may be used by the supervisory controller of FIG. 1 to adjust the power division between the internal combustion engine and electric machine characterized by the graphs of FIGS. 2 and 3.

FIG. 4A is a graphical view illustrating the degradation of battery capacity in proportion to Amp-Hour throughput.

FIG. 5 is a graphical view of the results of a plurality of test cycles of the supervisory controller of FIG. 1 using different values of proportional gain.

FIG. 6 is a graphical view of SOC, battery temperature, accumulated fuel, and equivalence factor trajectories using different adaptation intervals for the test cycles of FIG. 5.

FIG. 7 is a graphical view of a penalty factor that is based on the SOC of a battery of the HEV of FIG. 1.

FIGS. 8A and 8B are graphical views of Root Mean Square (RMS) values of the severity factor and battery power for different test cycles, values of ambient temperature, and SOC weighting factors.

FIG. 9 is a graphical view of curve-fitted results for the data of FIGS. 8A and 8B.

FIG. 10 is a graphical view of fuel consumption as a function of transmission ratio for an internal combustion engine.

FIGS. 11A and 11B are graphical views of a Willans line model for the internal combustion engine and the electric machine.

FIG. 12 is a flow chart of an A-ECMS based energy management process that may be implemented by the supervisory controller of FIG. 1.

FIGS. 13A-13C are graphical views of SOC, temperature, and equivalence factor trajectories for different severity factor thresholds.

FIGS. 14A-14C are graphical views of battery power correction trajectories for the severity factor thresholds of FIGS. 13A-13C.

FIGS. 15A-15C are graphical views of the severity factors for each of the cases of FIGS. 14A-14C.

FIG. 16 is a diagrammatic view of a supervisory controller, sensors, and powertrain components of the HEV powertrain of FIG. 1.

### DETAILED DESCRIPTION

Embodiments of the invention implement an A-ECMS in real-time to optimize fuel consumption while accounting for battery capacity degradation. It has been determined that there is a fundamental trade-off between fuel economy and battery capacity degradation in HEVs. However, it has been further determined that a dramatic savings on battery life is possible with a small cost on fuel consumption. To reduce battery aging effects, a cost is assigned to battery use based on the operating conditions. A battery severity factor σ is used to quantify the battery aging effect or cost based on the present operating conditions. The battery output may then be reduced when the severity factor σ indicates conditions may result in accelerated aging effects on the battery.

Equivalence between ECMS and PMP can be demonstrated, showing that the equivalence factor s is related to the co-state in the PMP solution. Thus, only one parameter must be adapted for online optimization, e.g., the co-state λ, which is shown to be related to the equivalence factor s in ECMS. Embodiments of the invention may perform parameter adaptation based on feedback on the SOC of the battery, which is the present level of charge in the battery as a percentage of the battery's full capacity. This is possible in energy management systems that employ multiple energy sources, such as a charge-sustaining HEV, by dynamically changing the value of the equivalence factor in real-time by contrasting the SOC deviation from a reference value.

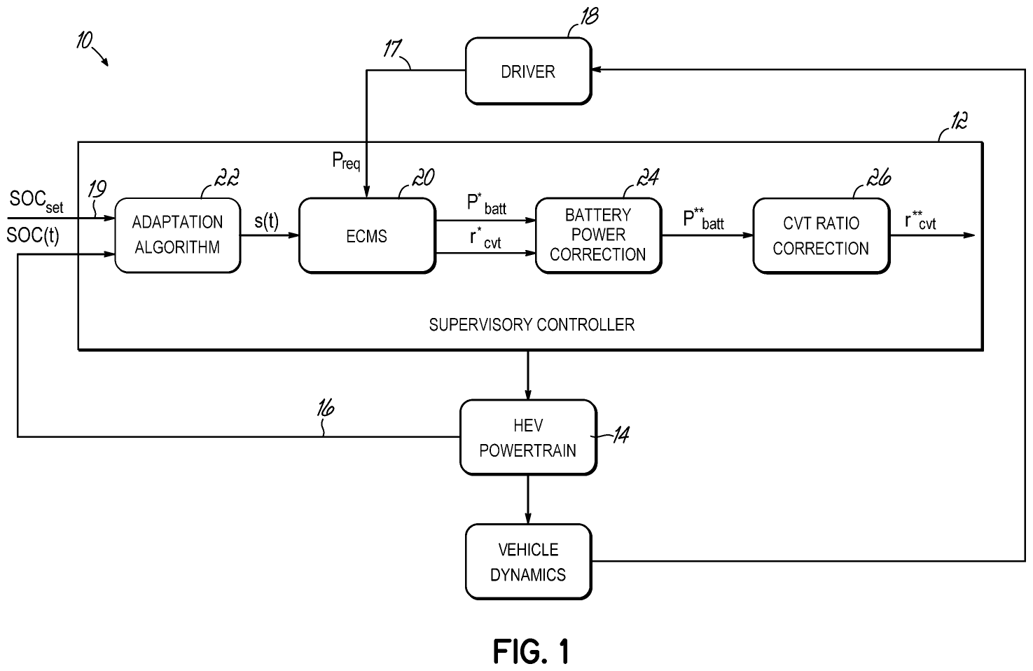

FIG. 1 provides a control diagram 10 depicting a supervisory controller 12 that receives one or more input signals from an HEV powertrain 14 (e.g., a signal indicative of the current SOC 16 of the vehicle battery pack) and/or other sources (e.g., signals indicative of a request for power 17 from a driver 18 and/or a target SOC 19). A real-time implementable ECMS may be implemented (e.g., using an ECMS module 20) with consideration of battery aging in accordance with embodiments of the invention based on an A-ECMS that uses an adaptation algorithm (e.g., implemented using an adaption algorithm module 22). An aging effect-based battery power correction function (e.g., implemented using a battery power correction module 24) may be developed based on the optimal performance from DP. In addition, a strategy for Constantly Variable Transmission (CVT) ratio correction may be implemented (e.g., using a CVT ratio correction module 26) to account for additional fuel saving from optimal shifting. Simulation results show that control algorithm in accordance with the above can achieve performance comparable to optimal solutions.

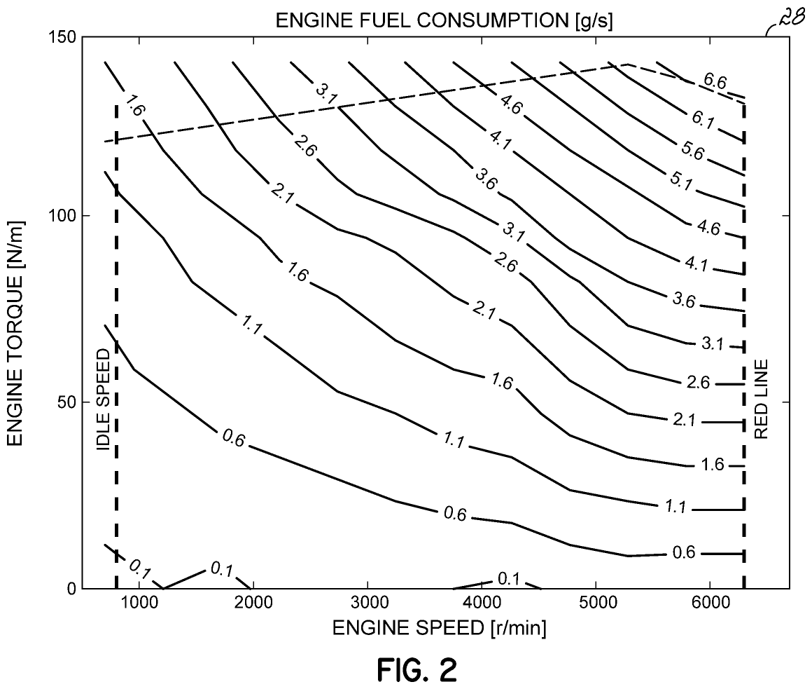

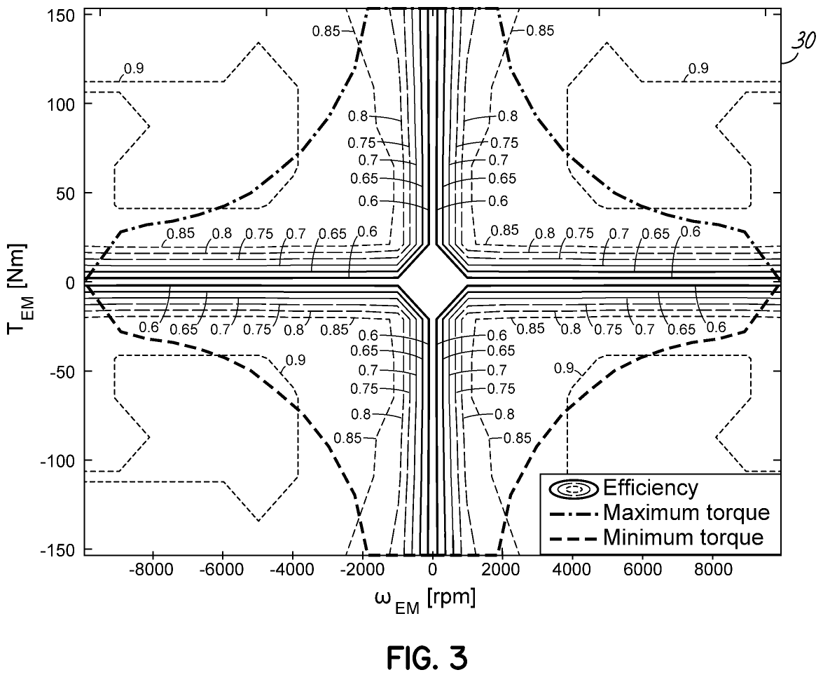

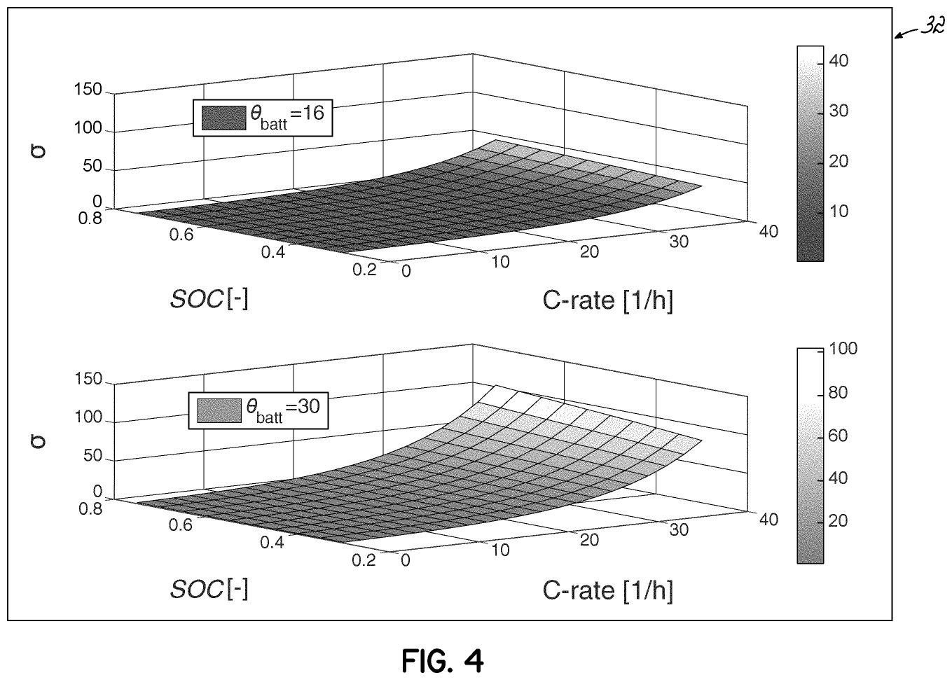

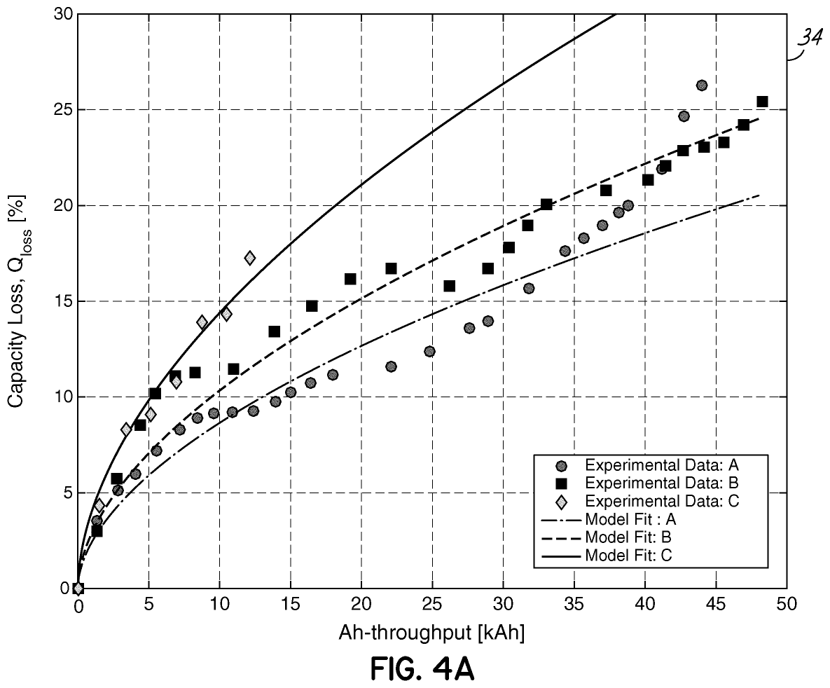

Elements for implementing the A-ECMS may include an internal combustion engine fuel consumption map 28, an example of which is depicted in FIG. 2, an electric machine efficiency map 30, an example of which is depicted in FIG. 3, and a battery severity factor map 32, an example of which is depicted in FIG. 4. The fuel consumption map 28 may be represented by a map or a table in the powertrain controller, and may provide fuel flow rates for various combinations of engine torque and engine speed. The battery severity factor map 32 may be developed using a battery capacity degradation model, and may be a function of battery temperature θ_{batt}, battery SOC, battery DOD, and/or battery charge/discharge rate or C-rate. The severity factor represents the relative aging effect of the load cycles the battery undergoes with respect to a nominal load cycle, which can be defined by the user.

The severity factor σ may be a positive dimensionless variable. When the value of the severity factor σ is greater than 1, it may indicate the existence of an aging condition that is more severe than the nominal condition. The severity factor may be a function of any or all of the variables that describe the state and operation of the battery, and may include temperature, SOC, DOD, and/or battery C-rate. A severity factor of 1 may correspond to ideal conditions, which are usually not attainable in practice during operation of a vehicle. Thus, the energy management strategy may allow a severity factor greater than 1 for at least a portion of the drive cycle.

The severity factor may be used to quantify the effective life reduction of the battery due to charge exchange within the battery by estimating the effective Ah to which the battery is subjected under specific operating conditions. Effective Ah is a concept related to the life of the battery under a specific condition, and can be used to describe the acceleration in aging caused by operating conditions in comparison to the nominal conditions. The effective Ah may be defined in terms of the severity factor and battery current as follows:

Ah_{eff}=∫₀^{t}σ(τ)·|I_{batt}(τ)|dτ Eqn. 1

If battery life is expected to reach N Ah when the battery is operated under nominal conditions (e.g., C-rate=1, θ=293.15 K (20° C.), 50% SOC, and 5% DOD), Ah_{eff} may represent the total Ah the battery will deliver during its useful life if operated under other operating conditions (e.g., a higher temperature, higher C rate, greater DOD, and/or higher or lower SOC). The battery reaches the end of life when Ah_{eff}=N.

The severity factor threshold σ̅ represents the value of a that we wish to set as the threshold between acceptable severity conditions, and conditions that will result in undesirable aging acceleration. The parameter σ̅ can be used as a calibration factor for tuning the energy management strategy to obtain the desired tradeoff between fuel economy and battery aging cost.

The internal combustion engine fuel consumption map 28, electric machine efficiency map 30, and battery severity factor map 32 may be generated when the powertrain configuration is determined. In addition, there may be one or more calibration parameters that are tuned for a desired level of performance. The calibration parameters may include an adaptation gain kₚ, an adaptation interval T, and the severity factor threshold σ̅. It has been determined that the overall performance of A-ECMS is robust with respected to kₚ and T, and the selection of σ̅ is dependent on the location of the desired performance on the Pareto front.

An exemplary battery degradation model is provided by:

$${Q}_{loss} = B \times ( \frac{- {E}_{a}}{R \times θ} ) \times {( Ah )}^{z} \qquad Eqn . 2$$

where Qₗₒₛₛ is the battery capacity loss in percentage with respect to the nominal capacity, B is a pre-exponential factor, Eₐ is the activation energy in J×mol⁻¹, R is the gas constant, θ is the battery temperature in Kelvin, Ah is the Ah-throughput, and z is the power law factor. The exemplary model provided by Equation 2 may be calibrated using battery aging data obtained from a charge sustaining HEV for three exemplary profiles shown in Table I. The data of profile A represents the battery operation in an actual city driving conditions in Gothenburg, Sweden, profile B illustrates battery usage in a load cycle designed over a stochastic process model for HEVs, and data of profile C is based on the outcome of an experimental test of batteries with load conditions from a real HEV driving cycle. The three profiles use the same type of battery, which is LiFePO₄ cell (ANR26650) from an A123 system, and are specified in terms of average state of charge SOC, average C-rate Ī_{c}, and average battery temperature θ̅. Following a two-step curve fitting procedure, the identified aging model can be expressed as:

$${Q}_{loss} = ( α \times S O C + β ) \times exp ( \frac{- 31700 + 163.3 \times {\overline{I}}_{c}}{R \times \overline{θ}} ) \times {Ah}^{0.57} \qquad Eqn . 3$$

where α=1287.6 and β=6356 for SOC≤0.45, and α=1385.5 and β=4193.2 for SOC>0.45.

TABLE I

| DATA | S̅O̅C̅ (%) | Ī_{c} ( 1/h) | θ̅ (° C.) |
|---|---|---|---|
| Profile A | 38.5 | 2.8 | 36 |
| Profile B | 42.0 | 3.0 | 38 |
| Profile C | 68.0 | 6.0 | 45 |

A battery severity factor map 32 developed from the above battery capacity degradation model may be obtained from battery validation experiments that characterize and validate the battery for electrified vehicle applications. Semi-empirical models may be used for on-line battery prognosis, estimation of state-of-health, and design of the battery management system. These models may be developed with consideration of simplified physical relations in the model by fitting the parameters of the model with experimental data obtained from aging tests. FIG. 4A depicts a graph 34 showing exemplary results of the above described battery validation experiments. Advantageously, the improvement in battery capacity as the battery ages provided by embodiments of the invention may enable HEVs including these features to operate more efficiently than conventional HEVs over their lifetimes.

The assumption behind the throughput model of Equation 3 is that a battery can withstand a certain amount of energy throughput subjected to a constant operating condition before it reaches the end of life. This may be equivalent to having the battery subjected to a number of charging and discharging cycles. Because operating conditions dictate battery aging phenomena, different battery life durations may be expected when the battery is operated under different inputs and environmental conditions. The severity factor a is utilized to quantify the relative aging effect with respect to a nominal operating condition. Defining the end-of-life of a battery as a certain percentage capacity drop from the battery's initial capacity, battery life with respect to a nominal cycle can be characterized by the total Ah-throughput when the battery reaches the end-of-life. The nominal battery life in terms of Ah-throughput can be expressed as:

Γ=∫₀^{EOL}|Iₙₒₘ(t)|dt Eqn. 4

where Iₙₒₘ is the current profile under nominal conditions.

When conditions are different than the nominal scenario, the amount of Ah that can be delivered before the end-of-life may be different. This can be expressed as:

γ=∫₀^{EOL}|I(t)|dt Eqn. 5

where γ(I, θ_{batt}, SOC) is the battery life in view of Ah-throughput corresponding to specific operating conditions in terms of current I, temperature θ, and SOC. The relative aging effects of any load cycles the battery is subject to can be reflected by the severity factor σ defined by Equation 6.

$$σ ( I , {θ}_{batt} , S O C ) = \frac{Γ}{γ ( I , {θ}_{batt} , S O C} = \frac{{\int }_{0}^{EOL} \vert {I}_{nom} ( t ) \vert dt}{{\int }_{0}^{EOL} \vert I ( t ) \vert dt} \qquad Eqn . 6$$

When the battery is undergoing a more severe load cycle, the severity factor σ may be greater than one, which is indicative of a shorter life expectancy. The severity factor may be obtained empirically using the aging model provided by Equation 3, or using any other suitable aging model.

Using ECMS in a charge-sustaining HEV, the change in energy stored in the battery pack at the end of a trip is normally negligible. This means almost all the energy used to propel the vehicle during the trip is ultimately obtained from burning fuel. Thus, the battery energy usage is converted to an equivalent amount of fuel and added to the real fuel consumption, which is defined as equivalent consumption and minimized instantaneously. Equation 7 provides an equivalent fuel consumption \dot{m}_{f,eqv}(t):

\dot{m}_{f,eqv}(t)=\dot{m}_{f}(t)+\dot{m}ᵣₑₛₛ(t) Eqn. 7

where \dot{m}_{f}(t) is the rate of fuel flow into the internal combustion engine, and \dot{m}ᵣₑₛₛ(t) represents a virtual fuel consumption associated with the use of electricity by the electric machine.

Using Equation 3, the instantaneous cost to be minimized is:

$${\dot{m}}_{f , eqv} ( t ) = \dot{m} ( t ) + {s}^{*} ( t ) \times \frac{{I}_{cell} ( t )}{3600 \times {Q}_{cell}} \qquad Eqn . 8$$

where s*(t) is an equivalence factor that is used to assign a cost to converting fuel into electric power in grams of fuel, I_{cell}(t) is the battery cell current, and Q_{cell} is cell capacity in amp-hours (Ah). The following equation can be derived from Equation 8:

$${s}^{*} ( t ) = \frac{s ( t ) \times {V}_{oc} \times {N}_{s} \times {N}_{p} \times {Q}_{cell} \times 3600}{L H V} \qquad Eqn . 9$$

where V_{GC} is the battery cell open circuit voltage, LHV is the lower heating value of the fuel (e.g., gasoline) in MJ/kg, and Nₛ and Nₚ are the numbers of battery cells in series and in parallel, respectively.

The online adaptation of the equivalence factor uses the difference between the value of the current SOC 16 (SOC(t)) and the value of the target SOC 19 (SOCₛₑₜ). One known adaptation law based on a proportional-integral (PI) controller may be used in which the equivalence factor continuously changes according to Equation 10:

s*(t)=s₀*(t)+kₚ(SOC₀−SOC(t))+k_{I}∫₀^{t}SOC₀−SOC(τ)dτ Eqn. 10

where s₀* is the initial value of s*, and kₚ and k_{I} are the proportional and integral gains of the adaptation law. The choice of s₀* can be made by averaging different optimal initial values obtained offline. This continuous adaptation law may prevent the use of battery energy when tracking a constant target value of SOC, which may fail to fully exploit the benefit of hybridization.

In order to allow the battery SOC to span a wider range, the following discrete-time adaptation law may be used:

$${s}^{*} ( k + 1 ) = \frac{{s}^{*} ( k + 1 ) + ( k )}{2} + {k}_{p} \times ( S O {C}_{0} - S O C ( t ) ) , \\ t = k \times T , k = 1 , 2 , … \qquad Eqn . 11$$

where s*(k+1) represents the new value of equivalence factor, which is applied in time window t∈[kT, (k+1)T], while s*(k−1) and s*(k) are the equivalence factor corresponding to the previous two time intervals, kₚ is the proportional gain of the feedback controller, and T is the duration of one interval. Both kₚ and T may be used as tuning parameters for the energy management strategy.

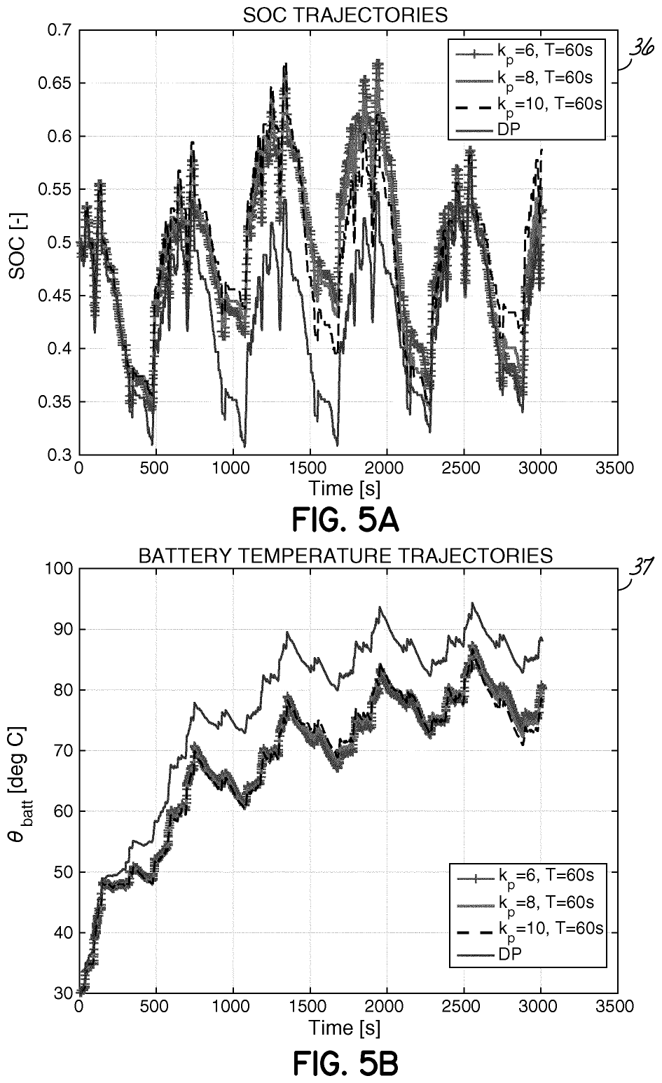

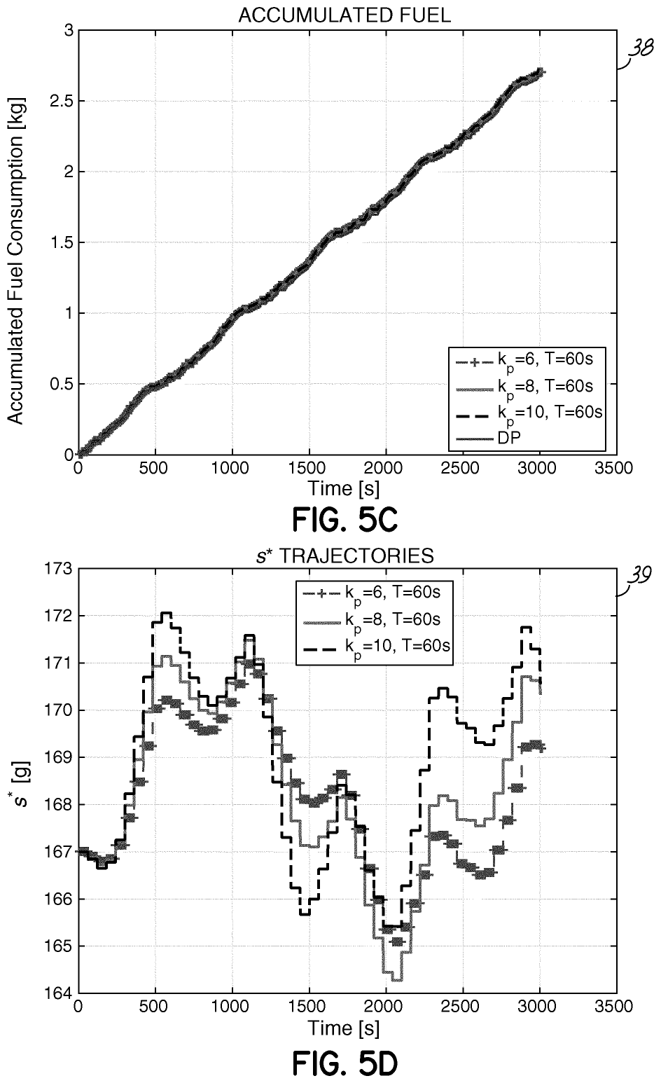

To study the effects of the gain kₚ and of the adaptation interval Ton the performance of the energy management strategy, simulation results may be compared. FIGS. 5A-5D depict graphs 36-39 illustrating results obtained from five consecutive US06 Supplemental Federal Test Procedure (SFTP) cycles, in which three different values of kₚ are studied, while the duration of the adaptation interval T is fixed at 60 seconds. The shapes of SOC trajectories are generally the same with minor differences. A similar observation can be made on the equivalence factor profiles, which is that the overall shapes are the same, and that as kₚ increases, the SOC profile has larger fluctuations.

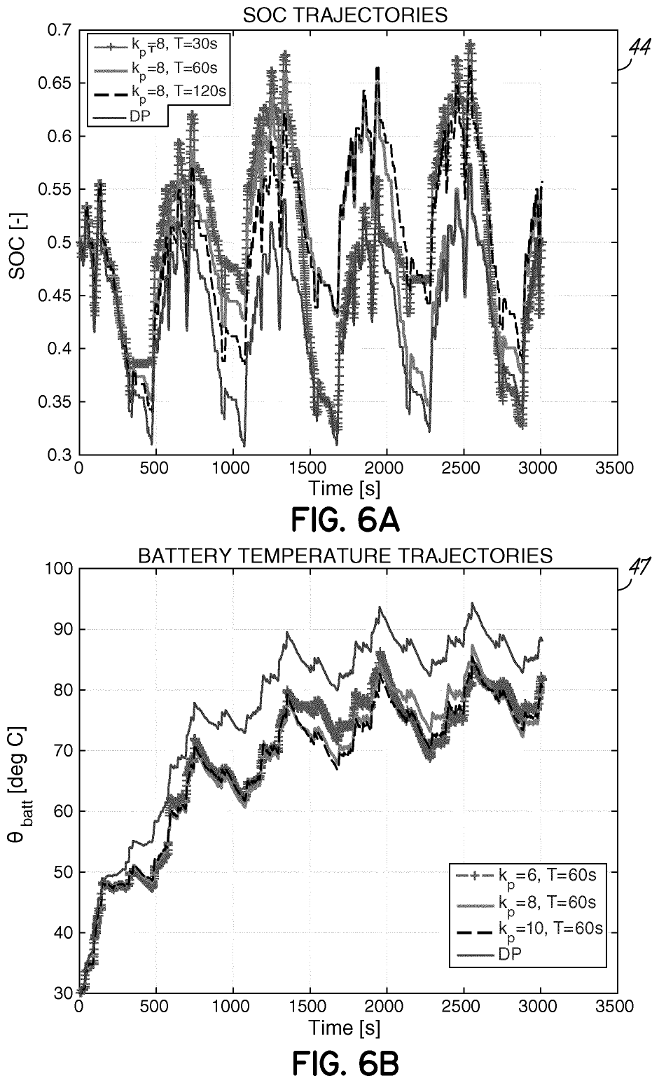

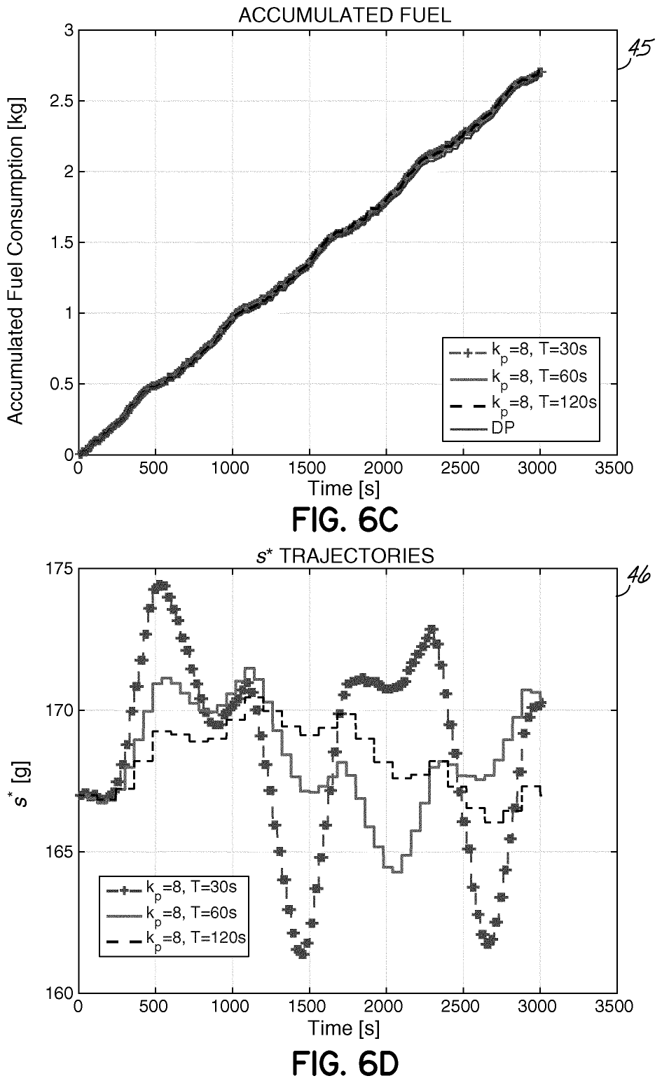

FIGS. 6A, 6C and 6D depict graphs 44-46 illustrating SOC, accumulated fuel consumption, and equivalence factor trajectories with different adaptation intervals at a proportional gain of kₚ=8. FIG. 6B depicts a graph 47 illustrating battery temperature trajectories with different values of kₚ at an adaptation interval T of 60 seconds. As can be seen, the equivalence factor trajectories are quite different, leading to different SOC profiles. In general, the smaller the adaptation interval is, the more dynamic the equivalence factor behavior is. Ideally, if T equals the entire driving time for the trip, s* would be the optimal constant equivalence factor for that driving cycle. The effect of the calibration parameters on US06 is summarized in Table II, in which

$$\frac{{m}_{f}}{{m}_{f}^{*}}$$

represents the fuel consumption f normalized by optimal fuel consumption from DP. Table II shows that the A-ECMS is within 1% of the DP results for this cycle, confirming that this sub-optimal algorithm is an excellent choice. Based on the simulation results from the two driving cycles, T=60 seconds and kₚ=8 are selected for the rest of the experimental results.

TABLE II

| | 6 | 8 | 10 |
|---|---|---|---|
| kₚ T[s] | $\frac{{m}_{f}}{{m}_{f}^{*}}$ | $\frac{{m}_{f}}{{m}_{f}^{*}}$ | $\frac{{m}_{f}}{{m}_{f}^{*}}$ |
| 30 | 1.008 | 1.012 | 1.012 |
| 60 | 1.008 | 1.008 | 1.010 |
| 120 | 1.007 | 1.009 | 1.008 |

Theoretically, SOC boundary conditions should be enforced by the adaptation interval. However, if the adaptation interval Tis long enough, SOC can touch the boundary or even break the constraints. To prevent this situation, a penalty function can be applied, which is used to guarantee that the SOC does not exceed the admissible limits. As an example, the penalty function can take the following form:

$$p ( S O C ) = 1 - {( \frac{S O C ( t ) - S O {C}_{0}}{\frac{( S O {C}_{max} - S O {C}_{min} )}{2}} )}^{9} \qquad Eqn . 12$$

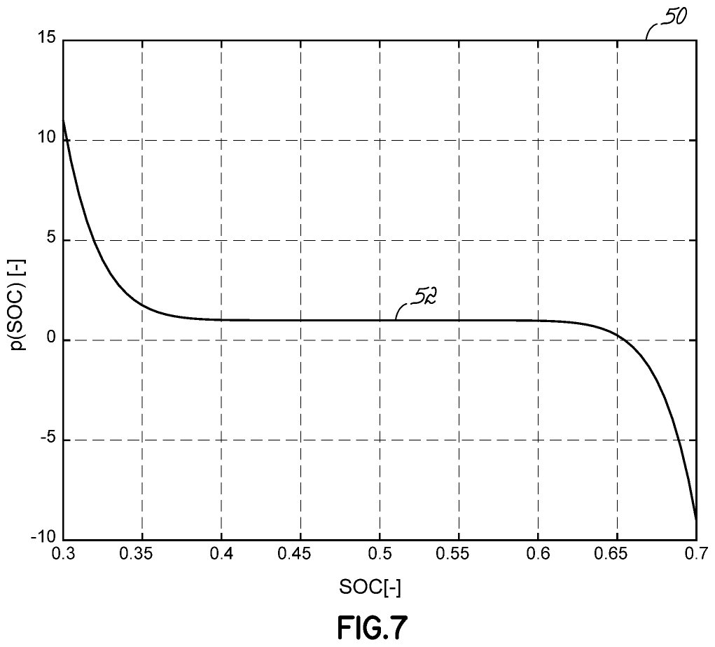

FIG. 7 depicts a graph 50 including a plot 52 illustrating an exemplary shape the penalty function may take for an allowable SOC range of between 0.3 and 0.7.

It may be concluded from all the optimal solutions, regardless of sequential or systematic approaches, that there exists a fundamental tradeoff between fuel economy and battery capacity degradation, and that it is possible to reduce battery capacity degradation with a small sacrifice in fuel economy. Embodiments of the invention may correct the battery power output if a severe aging condition is recognized, and may otherwise follow the command issued by the A-ECMS controller, which is nearly fuel-optimal.

Let σ* be the battery severity factor that results when the commands from the A-ECMS controller are followed, and let σ̅ be the severity factor threshold that defines an accelerated aging condition. Then battery power should be reduced any time when σ*>σ̅ to limit aging acceleration. A suitable correction law may be provided by Equation 13:

$$\vert {P}_{batt}^{**} \vert = \vert {P}_{batt}^{*} \vert \times ( 1 - w \times ln \frac{{σ}^{*}}{\overline{σ}} ) \qquad Eqn . 13$$

where P_{batt}** is the battery power after correction, P_{batt}* is the battery power corresponding to σ* that is the command from A-ECMS controller, and w is a calibration parameter. The reasoning behind the correction law of Equation 13 is based on the definition of the severity factor:

$$\frac{{σ}^{* }}{\overline{σ}} = exp ( \frac{163.3 \times ( {I}_{c}^{*} - \overline{{I}_{c}} )}{0.57 \times R \times {θ}_{batt}} ) = exp ( \frac{163.3 \times R \times ( \vert {P}_{batt}^{*} \vert - \vert {\overline{P}}_{batt} \vert )}{0.57 \times R \times {θ}_{batt} \times {V}_{oc} \times {N}_{s} \times {N}_{p} \times {Q}_{cell}} ) \qquad Eqn . 14$$

where I_{c}* and Ī_{c} are the C-rates corresponding to σ* and σ̅, and R is the gas constant. Therefore, the following expression can be derived:

$$\vert {\overline{P}}_{batt} \vert = \vert {P}_{batt}^{*} \vert - \frac{0.57 \times R \times {θ}_{batt} \times {V}_{oc} \times {N}_{s} \times {N}_{p} \times {Q}_{cell}}{163.3} \times ln \frac{{σ}^{*}}{\overline{σ}} = \vert {P}_{batt}^{*} \vert \times ( 1 - \frac{0.57 \times R \times {θ}_{batt} \times {V}_{oc} \times {N}_{s} \times {N}_{p} \times {Q}_{cell}}{163.3 \times \vert {P}_{batt}^{*} \vert} \times ln \frac{{σ}^{*}}{\overline{σ}} ) \qquad Eqn . 15$$

Comparing Equations 13 and 15, it can be concluded:

|P_{batt}**|=|P̅_{batt}| Eqn. 16

if

$$w = \frac{0.57 \times R \times {θ}_{batt} \times {V}_{oc} \times {N}_{s} \times {N}_{p} \times {Q}_{cell}}{163.3 \times \vert {P}_{batt}^{*} \vert} \qquad Eqn . 17$$

However, if the above equations were applied, the battery severity factor during one trip would be either below σ̅ or exactly equal to σ̅, which may fail provide desired vehicle behavior. Thus, the severity factor threshold σ̅ may be allowed to vary or oscillate to enable more flexible operation of the battery for purposes of improve drive quality. Since driving conditions, and therefore the severity factor, changes dynamically, the value of σ̅ may not necessarily be an instantaneous value, but could, for example, be the RMS of σ during a driving cycle. As described below, σ̅ may be used as a calibration parameter.

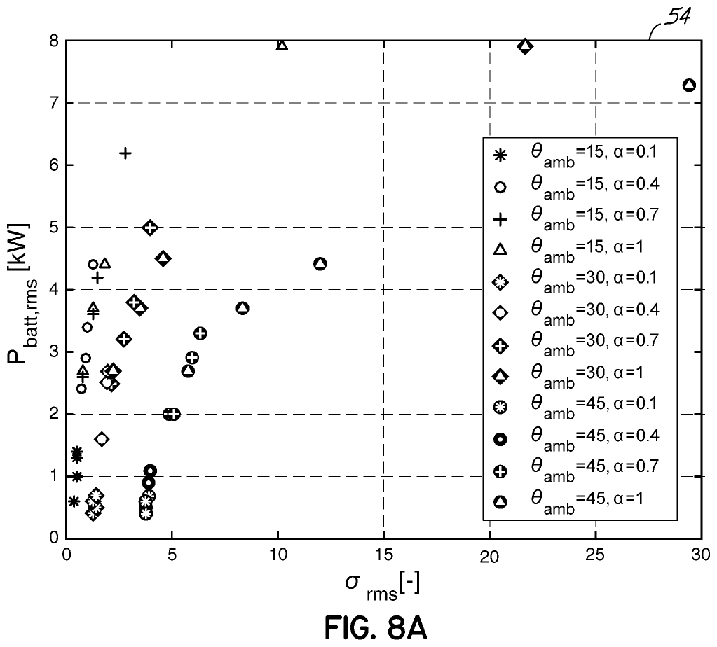

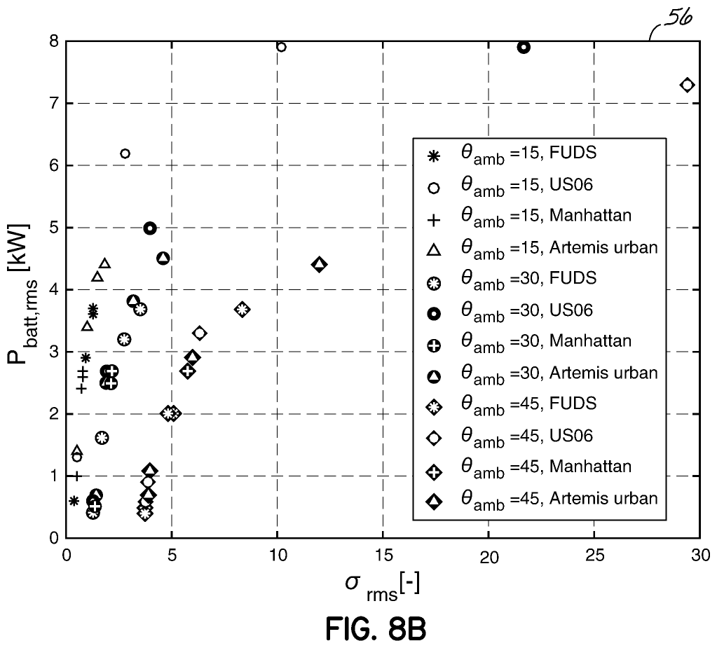

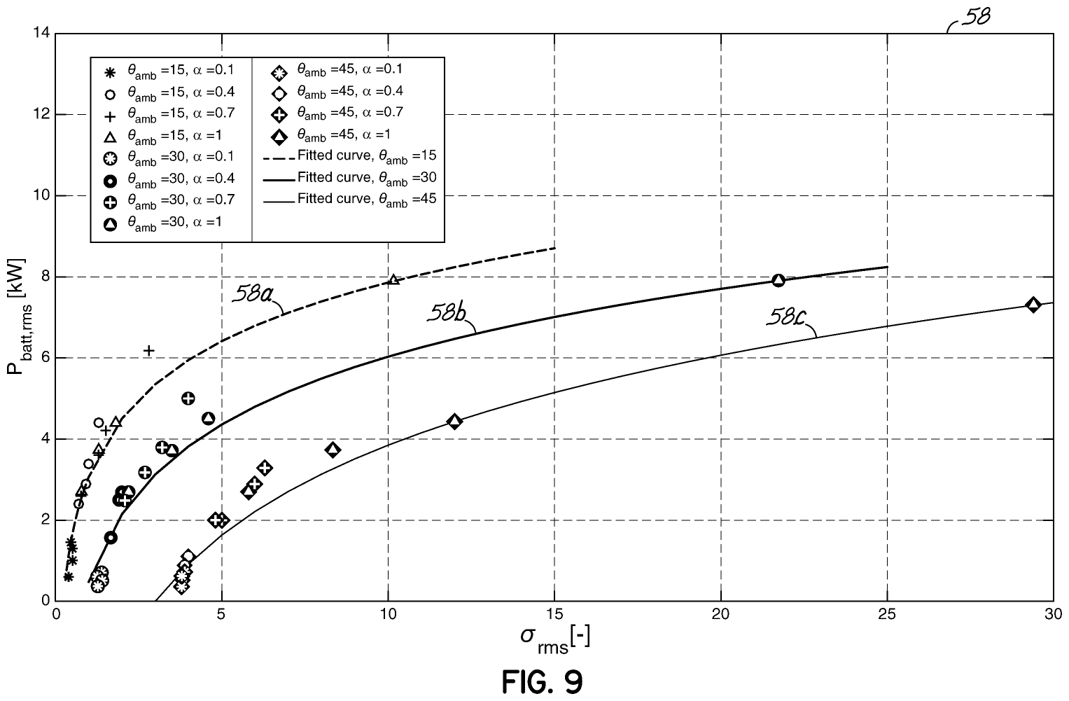

At this point, it may be instructive to analyze the systematic optimization results obtained from DP with four different driving cycles and four values of a at three ambient temperatures. FIGS. 8A and 8B depict graphs 54, 56 showing the RMS value of the severity factor σᵣₘₛ and the RMS value of battery power P_{batt,rms} for a set of data points for different driving conditions obtained using DP. The data in FIG. 8A is grouped by ambient temperature and α, while the same data in FIG. 8B is grouped by ambient temperature and driving cycle. A trend can be observed between σᵣₘₛ and P_{batt,rms} when looking at data obtained at the same ambient temperature regardless of α values and driving cycles. Equation 13 may be used to fit the data with the assumption that σ* is equal to the biggest σᵣₘₛ at each ambient temperature, and P_{batt}* is equal to the P_{batt,rms} corresponding to the biggest σᵣₘₛ. FIG. 9 depicts a graph 58 including plots 58a, 58b, 58c showing the curve fitted results for the data in FIGS. 8A and 8B, and the values of w listed in Table II. Plot 58a depicts the curve fitted results for θ_{amb}=15° C., plot 58b depicts the curve fitted results for θ_{amb}=30° C., and plot 58c depicts the curve fitted results for θ_{amb}=45° C.

TABLE III
VALUE OF w FOR CURVE FITTING

| θ_{amb} | 15° C. | 30° C. | 45° C. |
|---|---|---|---|
| w | 0.26 | 0.31 | 0.44 |

To have a general expression of w as a function of ambient temperature, an exponential function may be used to fit the data presented in Table III, which gives:

w=0.19×exp(0.02×θ_{amb}) Eqn. 18

Therefore, the battery power correction function may be provided by:

$$\vert {P}_{batt}^{**} \vert = \vert {P}_{batt}^{*} \vert \times [ 1 - 0.19 \times exp ( 0.02 \times {θ}_{amb} ) \times ln \frac{{σ}^{*}}{\overline{σ}} ] \qquad Eqn . 19$$

The battery power correction module 24 may be active only when σ*>σ̅, and |P_{batt}**| is bounded by 0 and |P_{batt}*|. Ideally, the controller is expected to have a Pareto-like behavior by changing the value of σ̅.

A battery power correction law that may be used to govern the battery power correction module 24 may be developed based on the optimal battery aging behavior obtained from the DP solutions. The correction law may have two parameters, namely θ_{amb} and σ̅. θ_{amb} is the ambient temperature, which is typically known, while σ̅ is used as a calibration parameter, which may be dependent on the type of the battery, the powertrain architecture, and/or the desired performance measure. The battery power correction function may be applied after the A-ECMS, leading to not only the correction on battery power but also the correction of the entire powertrain operating point, as explained below.

Battery power output may be corrected due to high-severity conditions when |P_{batt}**| is less than |P_{batt}*|. As a result, the corrected power output P_{ice}** of the internal combustion engine may need to be higher than the command power output P_{ice}* generated by A-ECMS so that the total power request is satisfied. For vehicles including a CVT, the new power split may also entail updating the transmission transfer ratio. From the comparison between systematic optimization and sequential optimization, it has been determined that transmission shifting with consideration of the total powertrain efficiency may provide superior results. Therefore, an optimization problem may be formulated and solved to search for the new optimal transfer ratio r_{cvt}** for the corrected power split between P_{batt}** and P_{ice}**. Although the transmission ratios are described herein in terms of adjusting the ratios in a CVT, the invention is not so limited. For example, a transmission having a plurality of selectable fixed ratios could also be used, in which case the energy management strategy would select the best ratio from the plurality of available ratios.

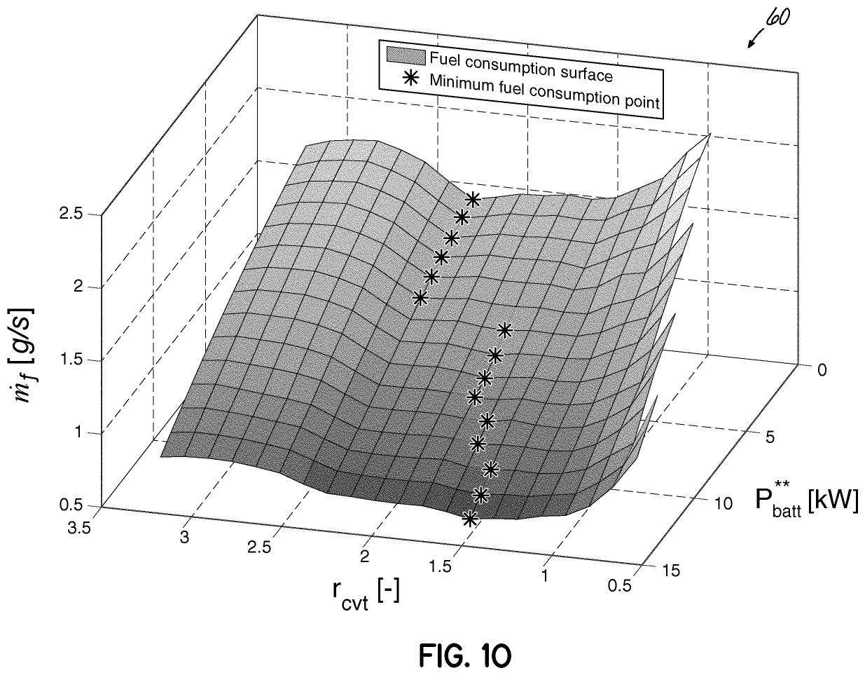

FIG. 10 depicts an exemplary three-dimensional graph of engine fuel consumption as a function of the transmission ratio with different levels of battery power at a fixed road power request of 21 kW. Although the battery power output may be fixed, the mechanical power output from the electric machine is dependent on the operating point of the machine on the efficiency map 30, which is determined at least in part by the transmission ratio. Thus, the engine operating point and fuel consumption may depend at least in part on the transmission ratio. The sum of the power from the electric machine and the internal combustion engine should meet the wheel power request, and engine power output as well as the operating point of the engine are dependent on the transmission ratio. Thus, for a given P_{batt}**, the engine fuel consumption may vary as the transmission ratio r_{cvt} changes, and the r_{cvt} that yields the minimum fuel consumption should be selected as r_{cvt}**.

An optimization problem may be formulated and solved to determine r_{cvt}**. To have the analytical expressions of fuel consumption and electric energy consumption of the electric machine, a Willans line model may be developed for both the internal combustion engine and the electric machine. In this representation, the energy conversion efficiency may only be dependent on the speed of the electric machine.

P_{fuel}=b₁(ω_{ice})×P_{ice}+b₂(ω_{ice}) Eqn. 20

Pₑₗₑ=c₁(ωₑₘ)×Tₑₘ²+c₂(ωₑₘ)×Tₑₘ+c₃(ωₑₘ) Eqn. 21

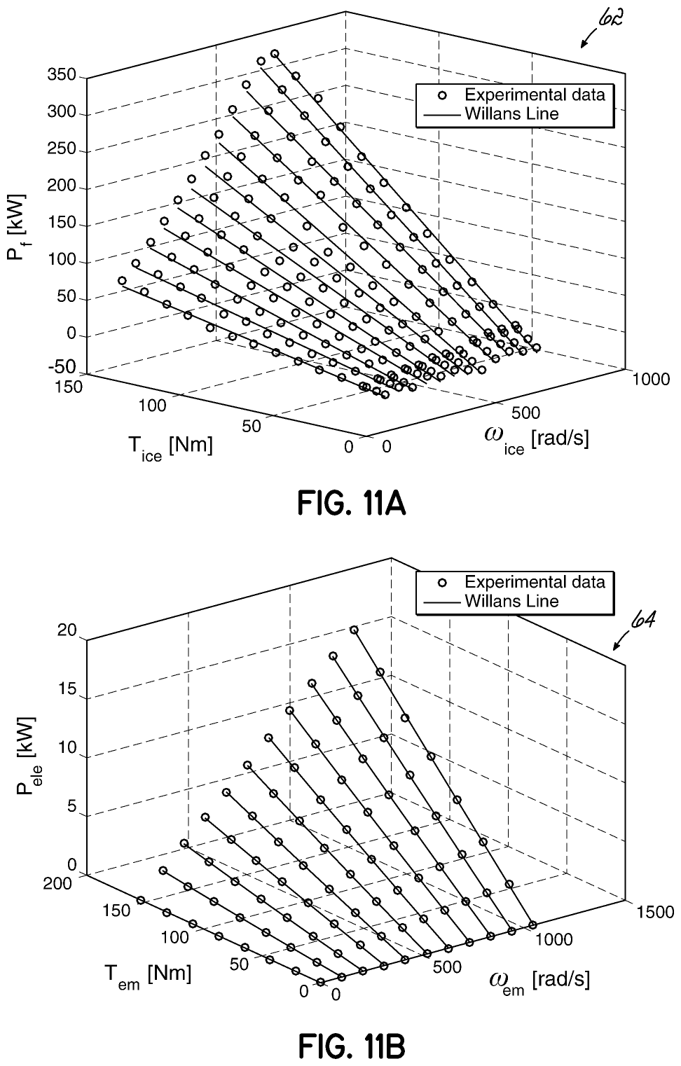

FIGS. 11A and 11B depict graphs 62, 64 illustrating the resulting Willans line model for both the internal combustion engine (FIG. 11A) and the electric machine (FIG. 11B). The Willans line model of FIG. 11A may be used to represent the relationship between input and output power in the internal combustion engine, in which the engine power is represented by an affine relationship in which the total fuel power P_{fuel} is a function of engine power P_{ice} and engine angular velocity ω_{ice}, as defined by the following:

P_{fuel}=b₁(ω_{ice})+b₂(ω_{ice}) Eqn. 22

The Willans line model of FIG. 11B may be produced by the following equation in which the total electrical power Pₑₗₑ is a function of electric machine torque Tₑₘ and angular velocity ωₑₘ.

Pₑₗₑ=c₁(ωₑₘ)·Tₑₘ²+c₂(ωₑₘ)·Tₑₘ+c₃(ωₑₘ) Eqn. 23

To compute the new optimal CVT ratio r_{cvt}**, an optimization problem may be formulated and solved using a computer program. For example, the below optimization problem (referred to collectively as Eqn. 24) may be solved using the built-in constrained function fmincon in MATLAB®, which is a program available from The MathWorks, Inc. of Natick, Mass.

min:P_{fuel}(t)

subject to

T_{road}(t)=(T_{ice}(t)+Tₑₘ(t)×η_{cvt}×r_{cvt}(t)×r_{diff}

ω_{ice}(t)=ωₑₘ(t)=ω_{wh}(t)×r_{cvt}(t)×r_{diff}

ωₑₘ(t)×Tₑₘ(t)×c₁(ωₑₘ)+c₂(ωₑₘ)=P_{batt}**(t)

0≤T_{ice}(t)≤T_{ice}_{ₘₐₓ}(ω_{ice}(t))

Tₑₘ_{ₘᵢₙ}(ωₑₘ(t))≤Tₑₘ(t)≤Tₑₘ_{ₘₐₓ}(ωₑₘ(t))

ω_{ice}_{ₘᵢₙ}≤ω_{ice}(t)≤ω_{ice}_{ₘₐₓ}

ωₑₘ_{ₘᵢₙ}≤ωₑₘ(t)≤ωₑₘ_{ₘₐₓ}

r_{cvt}_{ₘᵢₙ}≤r_{cvt}(t)≤ωr_{cvt}_{ₘₐₓ} Eqn. 24

With P_{batt}** and r_{cvt}**, the corrected operating condition of the powertrain may be determined for the given wheel power request. In general, if A-ECMS does not give commands that accelerate battery aging (σ*<σ̅), the control outputs from A-ECMS (P_{batt}* and are followed, otherwise the corrected battery power and corresponding CVT ratio (P_{batt}** and r_{cvt}**) are issued.

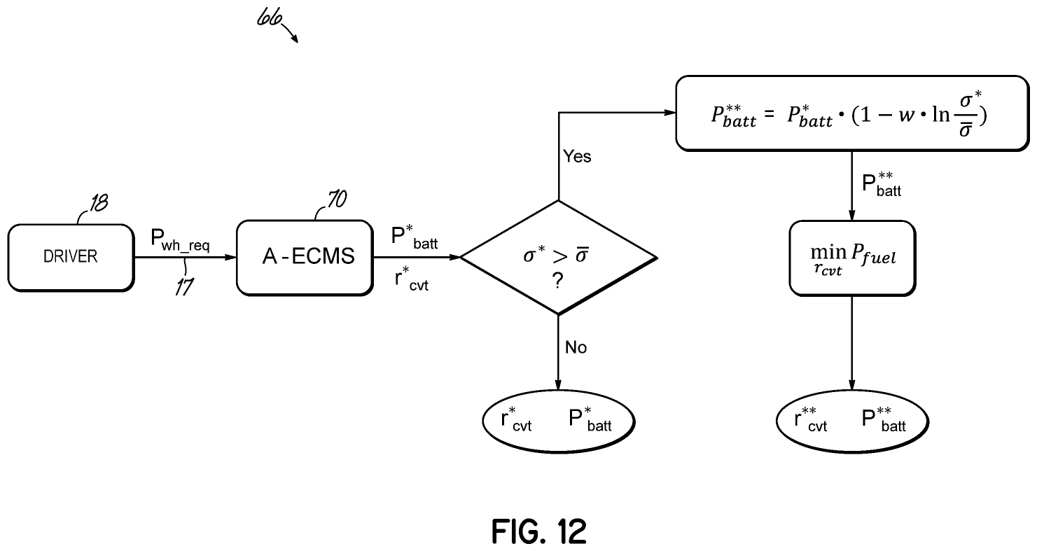

FIG. 12 depicts a flowchart of an A-ECMS based energy management process 66 that takes battery aging into consideration in accordance with an embodiment of the invention. The driver 18 of the vehicle provides the request for power 17, such as by pressing an accelerator that generates a signal indicative of an amount of power requested. An A-ECMS module (which may include one or more of the ECMS module 20, adaption algorithm module 22, battery power correction module 24, and/or CVT ratio correction module 26) receives this signal, determines the power split, and generates P_{batt}** and r_{cvt}** based on thereon. One or more of measured battery temperature θ_{batt}, voltage V, estimated SOC and DOD, and commanded battery power P_{batt}* are used to determine severity factor σ*. If the severity factor σ* is below the threshold σ̅, these values are used to control power delivery. If the severity factor is above the threshold σ̅, the battery power and transmission ratios are corrected accordingly, e.g., by reducing the battery power output based on Equation 13. The A-ECMS may choose an initial severity factor threshold σ̅, and calibrate σ̅ based on the desired performance measure, such as fuel economy and/or battery life depletion. Setting the threshold σ̅ higher may produce lower fuel consumption at the expense of increased aging of the battery.

### Experimental Results

To compare the performance of the aging-conscious A-ECMS with an A-ECMS configured for optimal power consumption, as well as to study the effects of using the severity threshold σ̅ as a calibration parameter on the energy management strategy, simulation results have been compared and analyzed. The below simulation data was generated using an ambient temperature of 30° C. A-ECMS related parameters gain kₚ and adaptation interval T were set to values of 8 and 60 seconds, respectively.

The performance of the aging-conscious A-ECMS strategy over the US06 driving cycle is summarized in Table IV. When varying the value of σ̅, a Pareto behavior of the controller can be observed, and the results of systematic optimization from DP with comparable performance measure are listed as well. It has been determined that the role of σ̅ in the real-time controller is the same as the role of α in the optimal controller. Because A-ECMS cannot guarantee that the final battery SOC is exactly equal to its initial value, the final fuel consumption is corrected for charge sustenance. Although the fuel consumption from the real-time controller is somewhat higher, the general performance is quite close to the optimal controller. In a real-world application, σ̅ may be selected based on the ambient conditions as well as the tradeoff preferences between fuel consumption and battery aging.

TABLE IV
PERFORMANCE OF AGING CONSCIOUS A-ECMS OVER US06

| Aging-Conscious A-ECMS | | | DP | | |
|---|---|---|---|---|---|
| σ̅ | Fuel (g) | Ah_{eff} | α | Fuel (g) | Ah_{eff} |
| 20 | 559 | 24.6 | 0.9 | 546 | 24.5 |
| 10 | 568 | 14.6 | 0.8 | 556 | 14.4 |
| 5 | 578 | 7.7 | 0.7 | 568 | 8.3 |
| 2 | 594 | 3.0 | 0.5 | 586 | 3.4 |

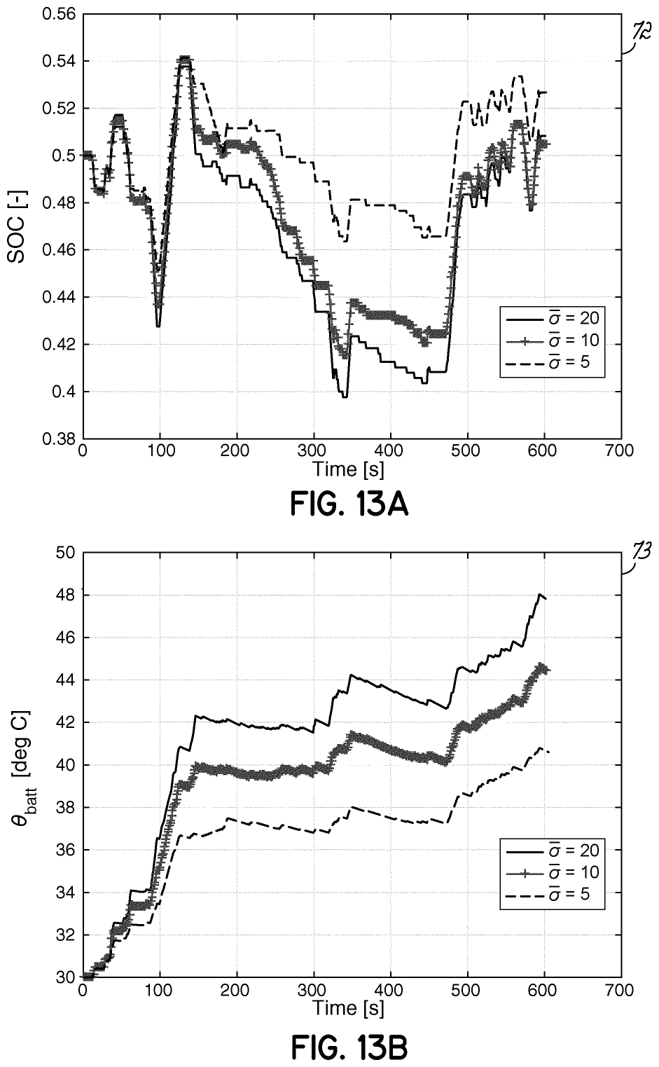

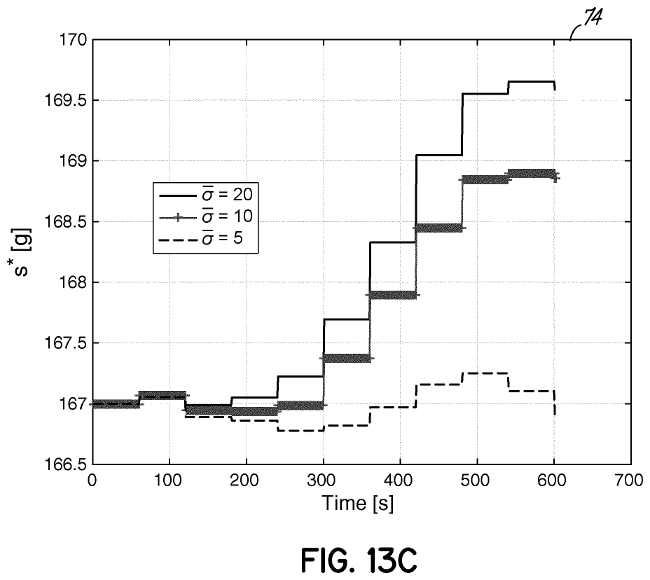

Detailed simulation results for three different values of σ̅ are studied to understand the control algorithm. FIGS. 13A-13C include graphs 72-74 depicting SOC, battery temperature, and equivalence factor trajectories verses time for varying values of the severity factor threshold. As can be seen, with a lower severity factor threshold, battery energy may be used in a less dynamic way, leading to lower battery temperature. The equivalence factor s* may be a result of the SOC profile. When the SOC is much lower than the target value, (e.g., 0.5 in the depicted case), s* may increase to bring back battery energy. On the other hand, s* may decrease when SOC is higher than the target value. Because the SOC trajectory with σ̅=5 has less fluctuation, the corresponding value of s* may be more stable than in the other two cases.

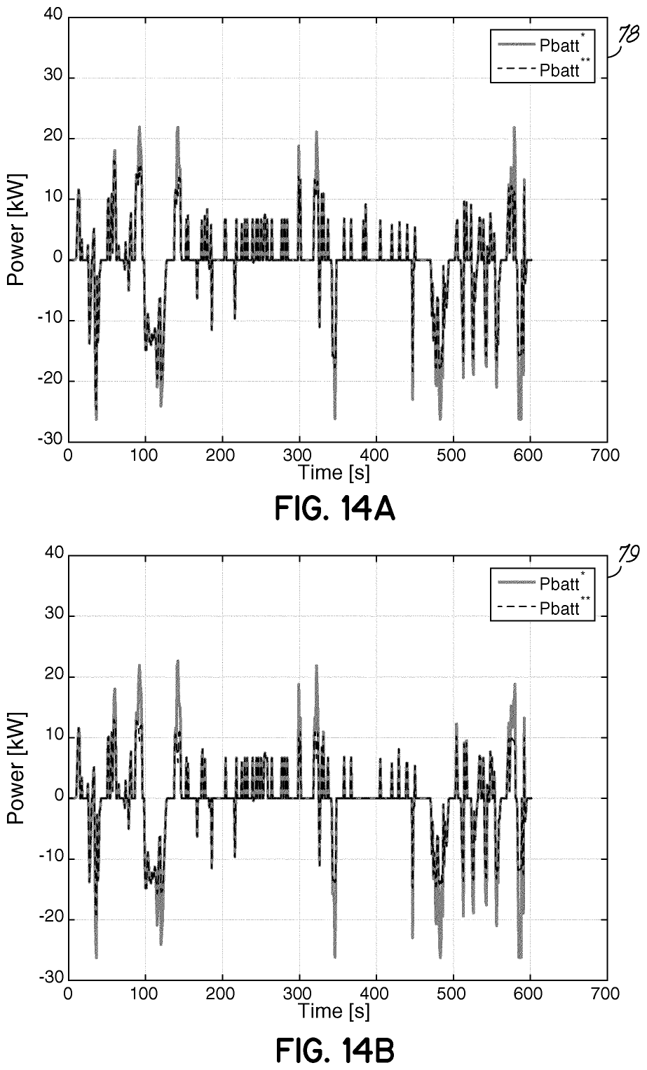

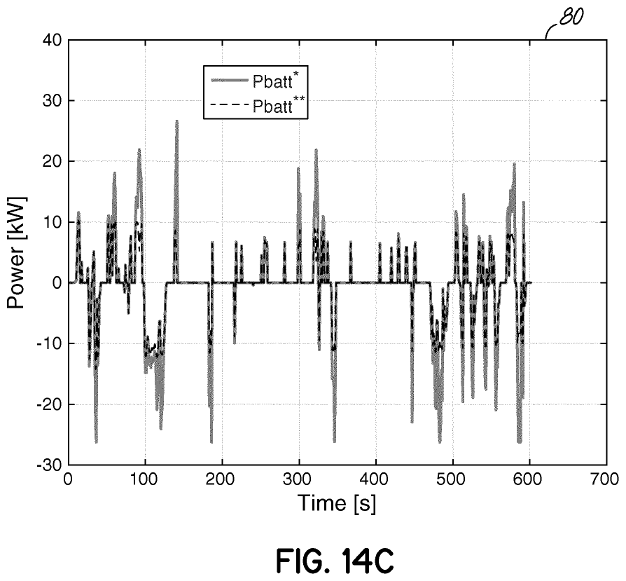

FIGS. 14A-14C depict graphs illustrating the battery power correction for three different severity factor thresholds, σ̅=20, σ̅=10, and σ̅=5, respectively. When σ̅ decreases, battery power output P_{batt}** is further corrected and compared with P_{batt}*. Because P_{batt}** influences SOC, and SOC has an impact on s*, P_{batt}* is different in each of the three cases depicted. Thus, the commands from the A-ECMS 70 (e.g., the values of P_{batt}*) are different in each case.

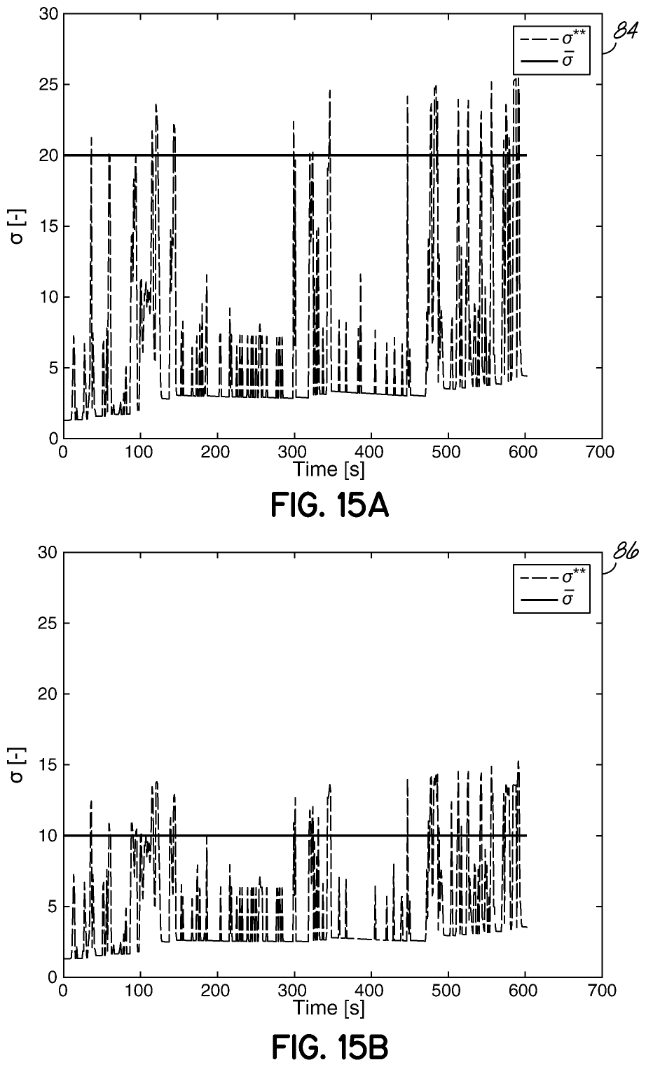

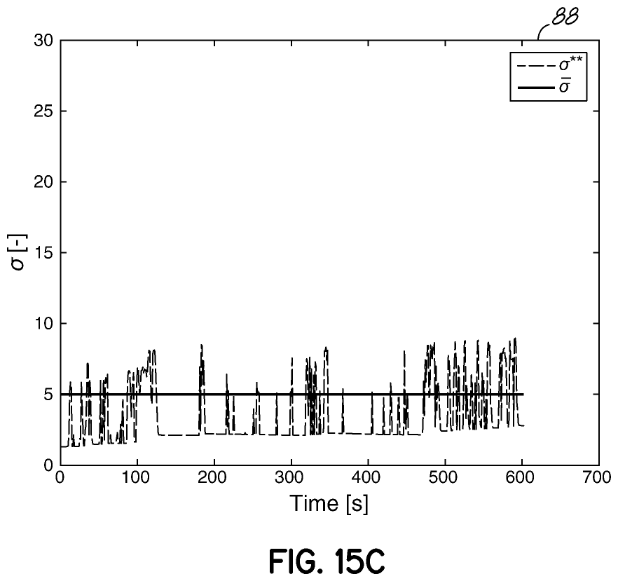

FIGS. 15A-15C depict graphs 84-86 illustrating severity factor profiles for each of the cases depicted by FIGS. 14A-14C. The severity factor profiles illustrated by FIGS. 15A-15C indicate that although battery power is corrected every time the severity factor reaches the threshold, a value of P_{batt}** that yields a severity factor bigger than the threshold (σ**>σ̅) is allowed when needed to achieve a desired performance level in the vehicle. This result may be achieved by using the correction function of Equation 19 instead of Equation 15. Similar observations can be made on the simulation results using the Federal Urban Driving Schedule (FUDS).

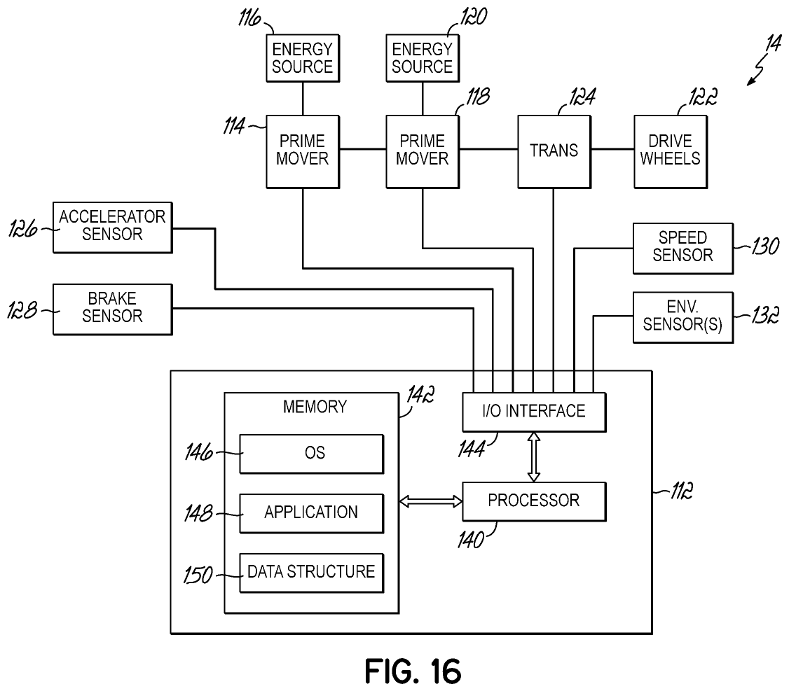

FIG. 16 depicts an exemplary HEV powertrain 14 that includes a supervisory controller 112 in accordance with an embodiment of the invention. The powertrain 14 may include one prime mover 114 (e.g., an internal combustion engine) that receives energy from one energy source 116 (e.g., a fuel tank), and another prime mover 118 (e.g., an electric machine) that receives energy from a different energy source 120 (e.g., a battery). Each of the prime movers 114, 118 may be coupled to drive wheels 122 by a transmission 124. Although the powertrain 14 is depicted as having the prime movers 114, 118 connected in series with the transmission 124, the invention is not limited to this configuration. For example, each of the prime movers 114, 118 could be connected to the transmission 124. As another example, the one prime mover 114 could be connected to a generator (not shown) that operates as an additional energy source for the additional prime mover 118. Thus, it should be understood that embodiments of the invention can be used with any hybrid configuration in which power is selectively provided to the drive wheels from multiple energy sources 116, 120.

The controller 112 may receive signals from an accelerator sensor 126, a brake sensor 128, a speed sensor 130, and one or more environmental sensors 132. The accelerator sensor 126 may provide the controller 112 with signals indicative of a request for power (e.g., to increase or maintain the speed of the vehicle), and the brake sensor 128 may provide the controller 112 with signals indicative of a demand to decrease the speed or otherwise retard movement of the vehicle. In response to signals from the brake sensor 128, the supervisory controller 112 may slow the vehicle using regenerative braking, for example. Speed sensor 130 may provide signals to the controller 112 indicative of the speed of the vehicle, and the environmental sensor(s) 132 may provide signals indicative of an environmental condition of the vehicle or a component thereof, such as battery temperature, current and/or voltage, SOC, DOD, engine or motor speed, road grade, or any other suitable operating condition of the HEV or a component thereof.

The controller 112 may include a processor 140, a memory 142, and an input/output (I/0) interface 144. The processor 140 may include one or more devices configured to manipulate signals (analog or digital) based on operational instructions that are stored in memory 142. Memory 142 may include a single memory device or a plurality of memory devices including, but not limited to, read-only memory (ROM), random access memory (RAM), volatile memory, non-volatile memory, hard drives, optical storage, mass storage devices, or any other device capable of storing data.

The processor 140 may operate under the control of an operating system 146 that resides in memory 142. The operating system 146 may manage controller resources so that computer program code embodied as one or more computer software applications, such as a supervisory controller application 148 residing in memory 142, can have instructions executed by the processor 140. One or more data structures 150 may also reside in memory 142, and may be used by the processor 140, operating system 146, and/or controller application 148 to store data. The supervisory controller application 148 may adjust the amount of power supplied or generated by each of the prime movers 114, 118 and/or the coupling between the prime movers 114, 118 and the drive wheels based on signals received from the sensors in accordance with the energy management strategy being implemented.

The I/O interface 144 operatively couples the processor 140 to the other components of the powertrain 14, and may also couple the processor 140 to an external computing system or network (not shown). The external computing system or network may be used, for example, to exchange data files, such as updated applications, and/or other operational data, with controller 112 to update the controller 112 and/or collect data related to the operation of the HEV.

The I/O interface 144 may include signal processing circuits that condition or encode/decode incoming and outgoing signals so that the signals are compatible with both the processor 140 and the components to which the processor 140 is coupled. To this end, the I/O interface 144 may include analog to digital (A/D) and/or digital to analog (D/A) converters, voltage level and/or frequency shifting circuits, optical isolation and/or driver circuits, protocol stacks, wireless transceivers, solenoids, relays, pneumatic valves, and/or any other devices suitable for coupling the processor 140 to the other components of the HEV and/or an external computing system.

The transmission 124 may include one or more input shafts that couple the transmission 124 to one or more of the prime movers 114, 118, and an output shaft that couples the transmission 124 to the drive wheels 122 of the vehicle. The transmission 124 may be configured to selectively couple the input shafts to the output shafts using one or more of a plurality of fixed ratios, continuously variable ratios, torque converters, and/or clutches under the direction of the supervisory controller 112.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A controller for a hybrid electric vehicle, the controller comprising:
a processor; and
a memory coupled to the processor, the memory including program code that, when executed by the processor, causes the controller to:
determine a severity factor for a first energy source for the hybrid electric vehicle based on one or more operating conditions;
receive a request for power; and
in response to receiving the request for power, determine a division of power between a first prime mover that receives energy from the first energy source, and a second prime mover that receives energy from a second energy source based at least in part on the severity factor of the first energy source.

2. The controller of claim 1 wherein the first energy source is a battery, and the program code is further configured to cause the controller to:
compare the severity factor to a threshold;
in response to the severity factor being below the threshold, determine the division of power that provides optimal energy efficiency from the hybrid electric vehicle; and
in response to the severity factor being above the threshold, adjust the division of power to reduce the power provided by the first energy source as compared to the division of power that provides optimal energy efficiency.

3. The controller of claim 2 wherein the threshold is varied to improve a drive quality of the hybrid electric vehicle.

4. The controller of claim 3 wherein the variation in the threshold is based on the request for power.

5. The controller of claim 3 wherein the threshold is equal to a root mean square of the severity factor.

6. The controller of claim 2 wherein an amount of power provided by the first energy source is reduced based on a ratio of the severity factor to the threshold.

7. The controller of claim 6 wherein the amount of power provided by the first energy source is reduced by a factor equal to unity minus a weighted logarithm of the ratio the severity factor to the threshold.

8. The controller of claim 1 wherein the first energy source is a battery, and the one or more operating conditions include at least one of a state of charge of the battery, a depth of discharge of the battery, a temperature of the battery, and a current of the battery.

9. The controller of claim 8 wherein an effect of the state of charge on the severity factor is weighted by a proportional gain, and the proportional gain is set to minimize the effect of at least one of the one or more operating conditions.

10. A method of controlling a hybrid electric vehicle, the method comprising:
determining a severity factor for a first energy source for the hybrid electric vehicle based on one or more operating conditions;
receiving a request for power; and
in response to receiving the request for power, determining a division of power between a first prime mover that receives energy from the first energy source, and a second prime mover that receives energy from a second energy source based at least in part on the severity factor of the first energy source.

11. The method of claim 10 wherein the first energy source is a battery, and further comprising:
comparing the severity factor to a threshold;
in response to the severity factor being below the threshold, determining the division of power that provides optimal energy efficiency from the hybrid electric vehicle; and
in response to the severity factor being above the threshold, adjusting the division of power to reduce the power provided by the first energy source as compared to the division of power that provides optimal energy efficiency.

12. The method of claim 11 wherein the threshold is varied to improve a drive quality of the hybrid electric vehicle.

13. The method of claim 12 wherein the variation in the threshold is based on the request for power.

14. The method of claim 12 wherein the threshold is equal to a root mean square of the severity factor.

15. The method of claim 11 wherein an amount of power provided by the first energy source is reduced based on a ratio of the severity factor to the threshold.

16. The method of claim 15 wherein the amount of power provided by the first energy source is reduced by a factor equal to unity minus a weighted logarithm of the ratio the severity factor to the threshold.

17. The method of claim 10 wherein the first energy source is a battery, and the one or more operating conditions include at least one of a state of charge of the battery, a depth of discharge of the battery, a temperature of the battery, and a current of the battery.

18. The method of claim 17 wherein an effect of the state of charge on the severity factor is weighted by a proportional gain, and the proportional gain is set to minimize the effect of at least one of the one or more operating conditions.

19. A computer program product for controlling a hybrid electric vehicle, the computer program product comprising:
a non-transitory computer-readable storage medium; and
program code stored on the non-transitory computer-readable storage medium that, when executed by a controller of the hybrid electric vehicle, causes the controller to:
determine a severity factor for a first energy source for the hybrid electric vehicle based on one or more operating conditions;
receive a request for power; and
in response to receiving the request for power, determine a division of power between a first prime mover that receives energy from the first energy source, and a second prime mover that receives energy from a second energy source based at least in part on the severity factor of the first energy source.
